(19) United States
(12) Patent Application Publication
(10) Pub. No.: US 2008/0212191 A1
(43) Pub. Date: Sep. 4, 2008

(54) Optical arrangement and optical method

(75) Inventors: Volker Harle, Laaber (DE); Alfred Lell, Maxhutte-haidhof (DE); Hubert Ott, Bad Abbach (DE); Norbert Stath, Regensburg (DE); Uwe Strauss, Bad Abbach (DE)

Correspondence Address: Thomas Langer, 551 Fifth Avenue, Suite 1210, New York, NY, 10176, US

(73) Assignee: Osram Opto Semiconductors GmbH, Regensburg (DE)

(21) Appl. No.: 12/072,842

(22) Filed: Feb. 27, 2008

(30) Foreign Application Priority Data
Feb. 28, 2007 (DE) 10 2007 009 820.2

(51) Int. Cl. G02B 27/10

(52) U.S. Cl. 359/618

(57) ABSTRACT

An optical arrangement comprising at least one first light-emitting element (LE1) and at least one second light-emitting element (LE2), and at least one light addition device (1) arranged in such a way that the light from the first and the second light-emitting element (LE1, LE2) are added to form a light beam.

### RELATED APPLICATION

This patent application claims the priority of German patent application no. 10 2007 009 820.2 filed Feb. 28, 2007, the disclosure content of which is hereby incorporated by reference.

### FIELD OF THE INVENTION

The invention relates to an optical arrangement and an optical method.

### BACKGROUND OF THE INVENTION

Light sources having high light intensity, high light density or high luminance find application in various areas of everyday life. Light sources for reading lamps, for endoscopy or microscopy can be mentioned here by way of example. Further applications, likewise from the area of everyday life, concern projection applications such as beamers or displays, for example, in which highly focussed light sources having high luminance are also of importance for displaying individual image pixels. Material processing, too, makes use of highly focussed light sources having high luminances. Examples can be found in the welding, engraving or cutting of workpieces.

Material processing, in particular, has hitherto been possible only with highly focussed light sources having a very high luminance. In this case, very high luminances have been attainable heretofore only by laser light sources.

Parabolic mirrors or lenses have been used heretofore for producing highly focussed light sources. This is shown for example in the document “Trichroic prism assembly for separating and recombining colors in a compact projection display”, Hoi-Sing Kwok et al., Applied Optics, Vol. 39, No. 1, Jan. 1, 2000, pp. 168-172. Optical devices of this type, as a light source, have a relatively large size and result in light sources having an extent of at least 1 mm or more. Furthermore, the light beams emitted by such light sources are not parallel to one another, but rather follow more of a star-shaped course.

In the case of image projections which display overall images formed from individual image pixels, the areal extent of an individual pixel is of crucial importance for the optical quality of the imaging. The smaller the areal extent of an individual image pixel, the better the optical quality of the imaging is perceived to be. However, the areal extent of the pixel is not the only factor of importance in this case; the brightness of the individual pixel also influences the perceived quality of the imaging. Weak light sources, in comparison with a light source having high luminous intensity, result in an image perceived as matt and having low contrast.

### SUMMARY OF THE INVENTION

One object of the invention is to provide a solution which makes it possible to obtain high imaging quality, with the luminance remaining the same.

The fact that a first light-emitting element and a second light-emitting element are provided, the individual light beams thereof being additively combined to form a common light beam, results in a total luminance which is higher than each of the individual luminances of the first or second light-emitting element. The luminances are added by means of a light addition device arranged in such a way that the individual light beams of the light-emitting elements which come from mutually deviating directions are combined to form a common light beam. This measure increases the total intensity of the light source thus produced by comparison with the individual luminances of the light-emitting elements.

In accordance with one development, provision is made for forming the light-emitting elements from at least one first semiconductor-based laser diode and at least one second semiconductor-based laser diode. What is achieved by this measure is that the emitted light from each individual light-emitting element is already emitted in longitudinally directed fashion in a parallel beam, whereby the further addition of the emissive light is simplified. Moreover, semiconductor-based laser diodes have a high output power relative to their light-emitting area.

In accordance with one development, provision is made for choosing mutually deviating wavelength ranges of the emitted light for the first and the second light-emitting element. What is thereby achieved is that a variation of the hue of the light source can be obtained by means of an addition of different-colored emitted light of different wavelengths of two or more laser diodes by a variation of the individual luminances at the individual laser diodes. A light source with a color tonality that can be varied can thus be formed by means of the light addition device.

In accordance with one development, provision is made for arranging an optical converter device into the beam path of the optical arrangement. The optical converter device brings about a change, a conversion of the wavelengths of the light passing through it. Preferably, at least part of the light passing through is converted in such a way that the wavelength of the converted light is longer than the wavelength of the non-converted light. By way of example, the non-converted light is blue light, and the converted light can then be yellow light, for example.

In this case, the arrangement of the optical converter device in the beam path is possible upstream of the light addition device or downstream of the light addition device. The light emerging from the converter device has a wavelength that is different than the wavelength of the entering light. Through a combination of suitable converter material and semiconductor-based laser diodes, light sources which have an exactly predeterminable color tonality can be produced in this way. Consequently, light sources of white light having different color temperatures can also be produced in this way.

In accordance with one development, the light is forwarded to the optical addition device by means of an optical fiber. What is achieved by means of the optical fiber is that the first and/or the second light-emitting element can be arranged at a different location than the light addition device, and the light is guided to the light addition device by means of the optical fiber. In accordance with this development, it is also possible for the light to be guided away from the optical addition device by means of an optical fiber. It is thus possible for the light source to be formed at a location at a distance from the optical addition device. In this case, the converter device can also be arranged at the end of the optical fiber and thus at the light exit point. This is advantageous when individual subcomponents have to be arranged at locations at a distance from one another on account of limited spatial sizes or on account of configurational or application-dictated requirements. One example of this is endoscopy, in particular.

In accordance with one development, provision is made for forming the light addition device from at least one optical element having an interface formed in such a way that the light of a predetermined wavelength range is reflected by the interface. Light outside said wavelength range penetrates through the interface. By way of example, the light from at least two light-emitting elements can be added in this way. For this purpose, the first light-emitting element is designed in terms of its wavelength range such that the light that it emits penetrates through the interface. The second light-emitting element is designed such that the light that it emits is reflected at the interface. If the light from the first light-emitting element impinges on the interface, then it penetrates through the interface and in the process is not deflected or is only slightly deflected, but not reflected. If the light from the second light-emitting element impinges on the interface, then it is reflected by the interface. Through a selected arrangement of the interface in relation to the position of the light-emitting elements and the orientation thereof, what can thus be achieved is that the reflected light from the second light-emitting element is optically added to the light from the first light-emitting element that has penetrated through the interface.

In accordance with one development, the converter device is thermally coupled to a cooling device. What is thus achieved is that a heat arising on account of high light energy during the conversion is dissipated from the converter device and damage to the converter device is thus avoided.

### BRIEF DESCRIPTION OF THE DRAWINGS

Exemplary embodiments are explained in more detail below with reference to the drawings, in which:

FIG. 1 shows a first exemplary embodiment of the optical arrangement,

FIG. 1A shows a graphical representation of the dependencies of the reflectivity on the emission wavelengths,

FIG. 2 shows a second exemplary embodiment of the optical arrangement,

FIG. 2A shows a graphical representation of the dependencies of the reflectivity on the emission wavelengths,

FIG. 3 to FIG. 14 show further exemplary embodiments of the optical arrangement.

### DETAILED DESCRIPTION OF THE DRAWINGS

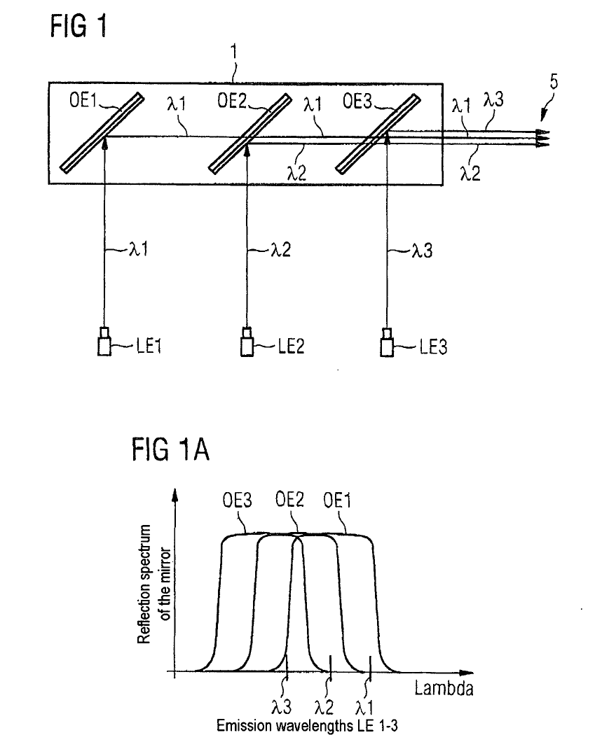

FIG. 1 shows a light addition device 1 in a schematic illustration. Light from three light-emitting elements LE1 to LE3 is fed into the light addition device 1. LE1 to LE3 are formed from semiconductor-based laser diodes in the exemplary embodiment.

The light emitted by the laser diodes LE1 to LE3 differs in each case by virtue of its wavelength λ. The wavelength λ of a light, in particular in the so-called visible range, is a measure of the color of the emitted light. The laser diodes LE1 to LE3 emit light of the wavelength λ1, λ2 and λ3 independently of one another. The different wavelengths λ1, λ2 and λ3 of the emitted light are also illustrated in the corresponding illustration of FIG. 1A by means of a bar-like marking at the abscissa axis (Lambda). Moreover, the wavelengths λ1, λ2 and λ3 are assigned to the laser diodes LE1 to LE3 in the illustration of FIGS. 1 and 1A. The light addition device 1 is formed from optical elements OE1, OE2 and OE3, which each have a partly transmissive mirror surface constituted in such a way that it is highly reflective to wavelengths of a specific wavelength range. The surface of the optical element is transparent to wavelengths outside said wavelength range.

A cost-effective deflection mirror can also be used instead of the first optical element OE1 since only the light from the first laser diode LE1 is applied to the optical element OE1. The optical element OE1 is not penetrated by a light beam in the case of this arrangement.

In its further beam course, the deflected beam λ1 of the first laser diode LE1 then impinges on the optical element OE2 from a rear side. The optical element OE2, in the same way as the optical element OE1 and the optical element OE3, is arranged at an angle inclined by 45° with respect to the incident light beams λ1, λ2 and λ3. The incident light beams λ1, λ2 and λ3 impinge on the optical elements OE1, OE2 and OE3 at a distance from one another in a parallel direction. This arrangement has the effect, on the one hand, that the light beam emitted by the laser diodes is deflected by 90° at the respective optical elements and thus reflected. On the other hand, this arrangement has the effect that the light beam λ1 impinging on the optical element OE2 from the rear side penetrates through this and is not reflected. The optical element OE2 is designed in such a way that it is highly reflective to light beams of the wavelength λ2, but the light beams of the wavelength λ1 can penetrate through without being reflected.

The arrangement of the optical elements inclined by 45° therefore brings about an addition of the light beams λ1 and λ2. In the further beam course, the sum of the two light beams λ1 and λ2 impinges on the third optical element OE3 from a rear side. In this case, the optical element OE3 is designed in such a way that it has the effect of being transparent to the wavelengths of the beams λ1 or λ2 and has highly reflective properties for the wavelengths λ3 of the third laser diode. Accordingly, the light beams λ1, λ2 and λ3 leave the optical element OE3 in a common parallel direction, and hence the optical light addition device 1. A light source 5 comprising the sum of the individual light beams λ1, λ2 and λ3 is thus formed. A light is thus generated having a luminance that is formed by addition from the luminances of the individual laser diodes LE1, LE2 and LE3.

FIG. 1A further shows the relationship between the individual wavelength ranges λ1, λ2 and λ3 of the laser diodes and shows a respective exemplary reflection spectrum of the individual optical elements OE1, OE2 and OE3. Accordingly, the optical element OE1 reflects all wavelengths of the wavelengths λ1, λ2 and λ3 that occur in the exemplary embodiment illustrated, since the wavelength ranges thereof all lie within the reflection spectrum of the first optical element OE1. The exemplary embodiment from FIG. 1 shows in combination with FIG. 1A that the optical element OE1 does not have to be transmissive to any of the three wavelengths λ1, λ2 or λ3. Only the wavelength λ1 of the laser diode LE1 is reflected.

FIG. 1 further shows that the light beam of the wavelength λ1 is not reflected at the optical element OE2. As shown in FIG. 1A, the wavelength λ1 lies outside the reflective range of the optical element OE2. The wavelength λ2 lies within the wavelength range in which the optical element OE2 has a reflective effect. Consequently, the light beam of the wavelength λ2 is reflected at the optical element OE2. Light of the wavelength λ1 is not reflected at the optical element OE2 and penetrates through the optical element OE2. Light of the wavelength λ2 is reflected at the optical element OE2. The wavelength range in which the optical element OE3 has a reflective effect is formed in such a way that only the wavelength λ3, but not the wavelength λ2 or λ1, is reflected. Light of the wavelength λ2 or λ1 therefore penetrates through the optical element OE3 and light of the wavelength λ3 is reflected at the optical element OE3.

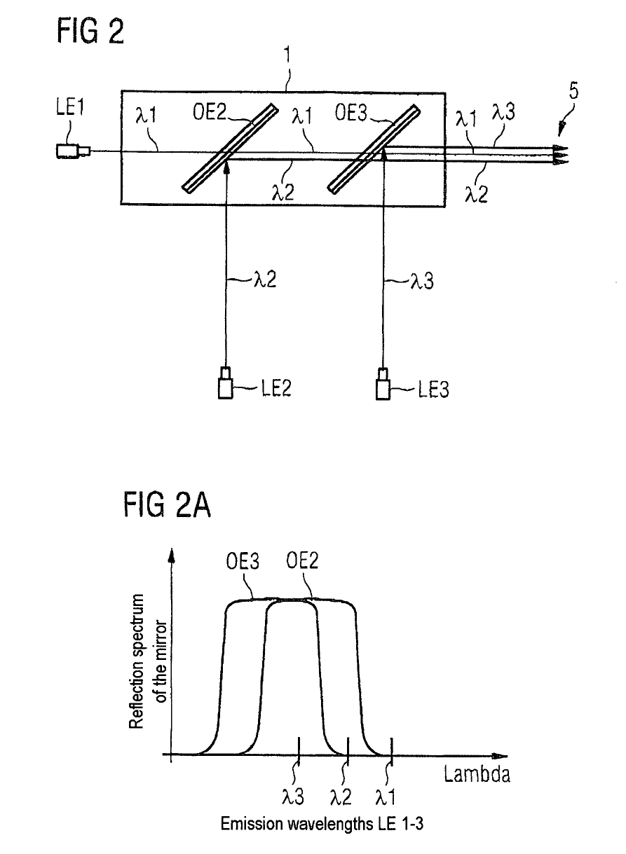

FIG. 2 and FIG. 2A show an exemplary embodiment which can be produced more cost-effectively by comparison with the exemplary embodiment illustrated in FIG. 1. The exemplary embodiment of FIG. 2 has one optical element OE fewer by comparison with the exemplary embodiment of FIG. 1. The optical element OE1, functioning only as a deflection mirror, has been omitted in the exemplary embodiment of FIG. 2 by comparison with the exemplary embodiment of FIG. 1. The laser diode LE1 is now arranged in altered fashion by comparison with the exemplary embodiment of FIG. 1 in such a way that the light beam λ1 emitted by the light element LE1 now impinges, from a direction altered by 45°, directly on the rear side of the optical element OE2 without previous deflection. The optical element OE1 is therefore eliminated. The material and assembly costs associated with the optical element OE1 in the production of the optical arrangement are therefore obviated.

FIG. 2A shows that even when dispensing with the reflection spectrum of the optical element OE1, the optical elements OE2 and OE3 provide enough wavelength ranges for reflection in order to reflect the wavelengths of the laser diodes LE2 and LE3 at the optical elements OE2 and OE3 and therefore likewise to obtain at the output of the light addition device 1 a total light beam formed by the three light beams λ1, λ2 and λ3, and thus a light source.

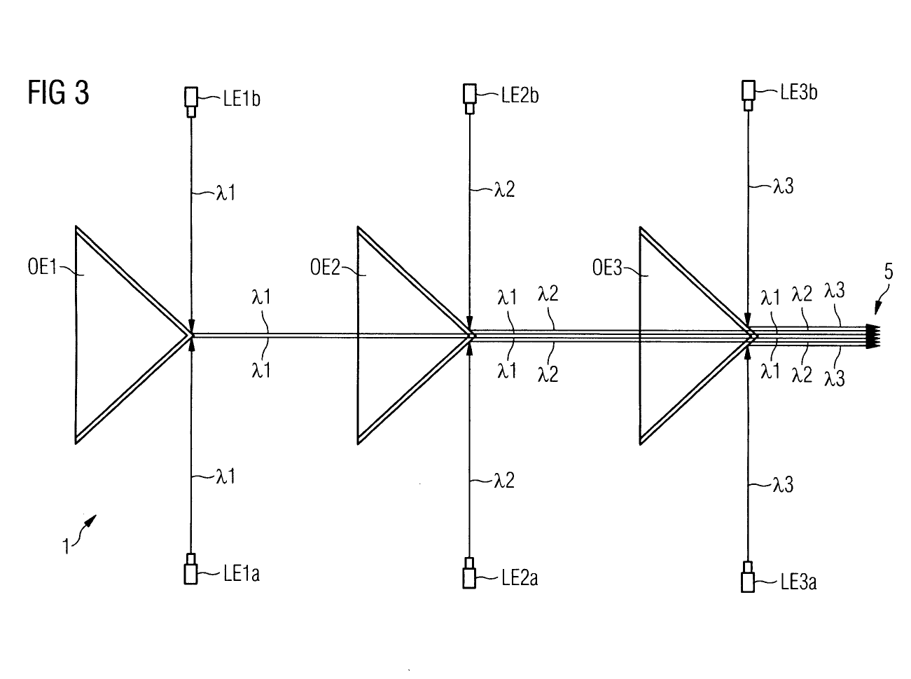

FIG. 3 shows a light addition device which now adds the light from a total of six laser diodes LE1a, LE1b, LE2a, LE2b, LE3a and LE3b with a total of three different wavelength ranges λ1 to λ3 to form a common light source 5. Said light addition device is formed from prism-like optical elements OE1, OE2 and OE3, the optical elements, in the same way as the optical elements of the exemplary embodiment from FIG. 1 or FIG. 2, being designed in such a way that they reflect the respective wavelengths of the light-emitting elements LE1, LE2 and LE3 assigned to them. The light of the light-emitting elements which are not assigned to them penetrate through the optical elements OE2 or OE3. In the same way as already explained with regard to the exemplary embodiments of FIGS. 1 and 2, the surfaces of the optical elements 1 are formed in such a way that the light of the wavelength λ1 that is emitted by the laser diodes LE1a and LE1b is reflected at the surface of the first optical element OE1. The laser diodes are arranged in such a way that the light beams of the laser diodes LE1a and LE1b impinge on the surface of the first optical element OE1 in each case from mutually different directions. The geometrical arrangement in the exemplary embodiment is formed in such a way that the surface of the first optical element OE1 is inclined at an angle of 45° with respect to the light beams of the laser diodes. The light beams are therefore deflected with an angle of 90° and leave the optical element OE1 in a parallel direction.

The surface of the optical element OE1 is formed in such a way that it exactly reflects the wavelength of the light emitted by the laser diode LE1a and LE1b. The optical element OE2 is furthermore formed in such a way that the wavelength λ1 penetrates through the optical element OE2. The wavelengths of the laser diodes LE2a and LE2b are reflected at the surface of the optical element OE2. The light beams of the wavelength λ1 impinge on the optical element OE2 and leave the latter without experiencing a deflection, in a direction parallel to the light beams of the laser diodes LE2a and LE2b. The optical element OE2 is oriented with its surfaces with respect to the laser diodes LE2a and LE2b in such a way that the emitted beams of the wavelength λ2 are reflected at its surface and leave the optical element OE2 in a direction identical to the light beams of the wavelength λ1. The sum formed in this way from the beams λ1 and λ2 of the laser diodes LE1a, LE1b, LE2a and LE2b then impinges as a common light beam on the rear side of the optical element OE3.

The optical element OE3 is formed in such a way that it has the effect of being transmissive to light of the wavelength λ1 and λ2 and reflects the light of the wavelength λ3, which is emitted by the laser diodes LE3a and LE3b, at its surface. The surfaces of the optical element OE3 are in turn formed in such a way that the light beam having the wavelength λ3 that is incident from the light-emitting elements LE3a and LE3b is reflected and leaves the optical element OE3 together with the light beams λ1 and λ2 in a common direction. Therefore, at the end of the light addition device 1, a light source 5 is formed which cumulates from the individual light beams λ1, λ2 and λ3 and thus comprises, in its intensity, the sum of the individual intensities of the light beams of the laser diodes LE1a, LE1b, LE2a, LE2b, LE3a and LE3b.

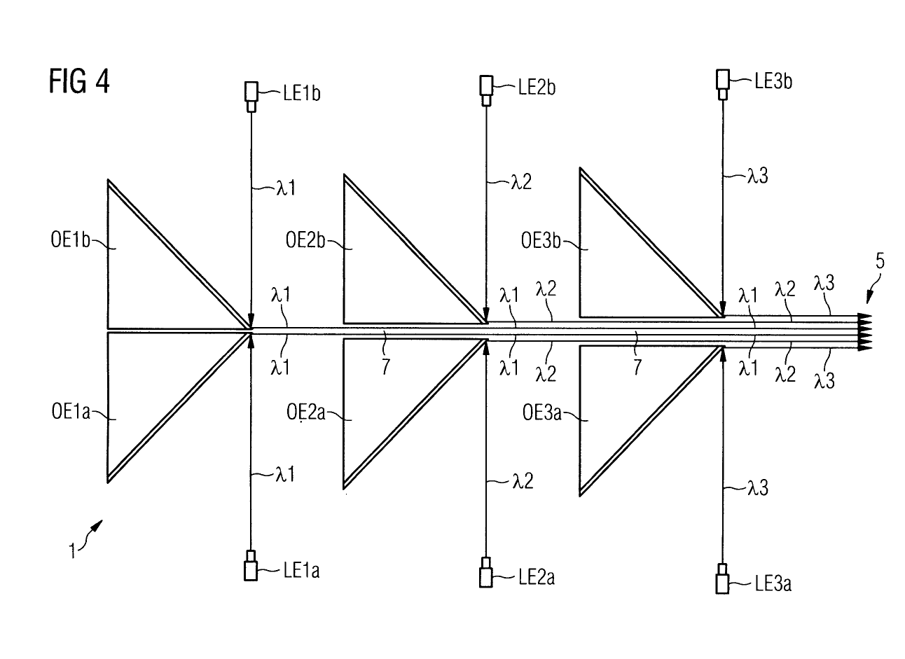

FIG. 4 describes an exemplary embodiment in which the optical elements OE1 to OE3 have a penetration zone 7 which is free of scattering and absorption losses and is set up for allowing the light beams to pass through unimpeded. Absorption losses which otherwise occur when penetrating through the optical element are thus avoided. In the example, this is represented by the optical elements OE1 to OE3 being separated into optical elements OE1a, OE1b and OE2a and OE2b, and OE3a and OE3b. In further respects the exemplary embodiment of FIG. 4 corresponds to the exemplary embodiment from FIG. 3. The beam bundle formed by the deflection at the reflective surfaces penetrates through the light addition device in unimpeded fashion and without scattering and absorption losses along the penetration zone 7 that is free of scattering and adsorption losses. Thus, the light intensity on account of the lower losses at the light source 5 is higher than in the exemplary embodiment shown in FIG. 3.

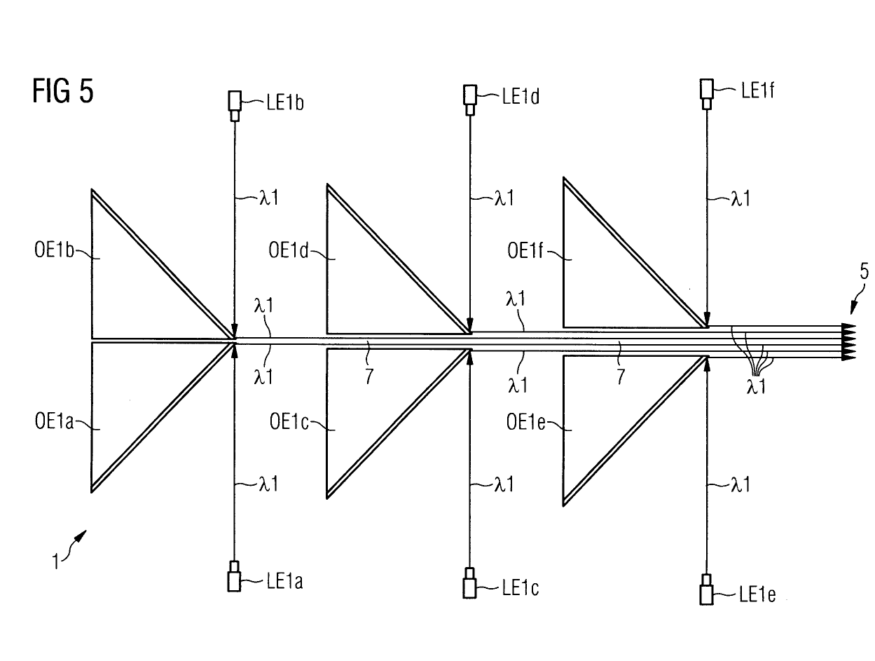

FIG. 5 shows an exemplary embodiment in which the light-emitting elements LE1a, LE1b, LE1c, LE1d, LE1e and LE1f are provided which all emit light of the same wavelength λ1. The geometrical arrangement of the optical elements OE1a to OE1f of the light addition devices 1 of the exemplary embodiment of FIG. 5 corresponds to the light addition device 1 of the exemplary embodiment illustrated in FIG. 4. The surface of the optical elements OE1a, OE1b, OE1c, OE1d, OE1e and OE1f is designed for reflection of the wavelength λ1. The formation of a penetration zone 7 free of scattering and absorption losses at the individual optical elements OE1a and OE1b and OE1c and OE1d, and OE1e and OE1f results in a common light beam as light source 5 which has added the light intensities of the individual light-emitting elements LE1a, LE1b, LE1c, LE1d, LE1e and LE1f and has the wavelength λ1 over the entire beam path.

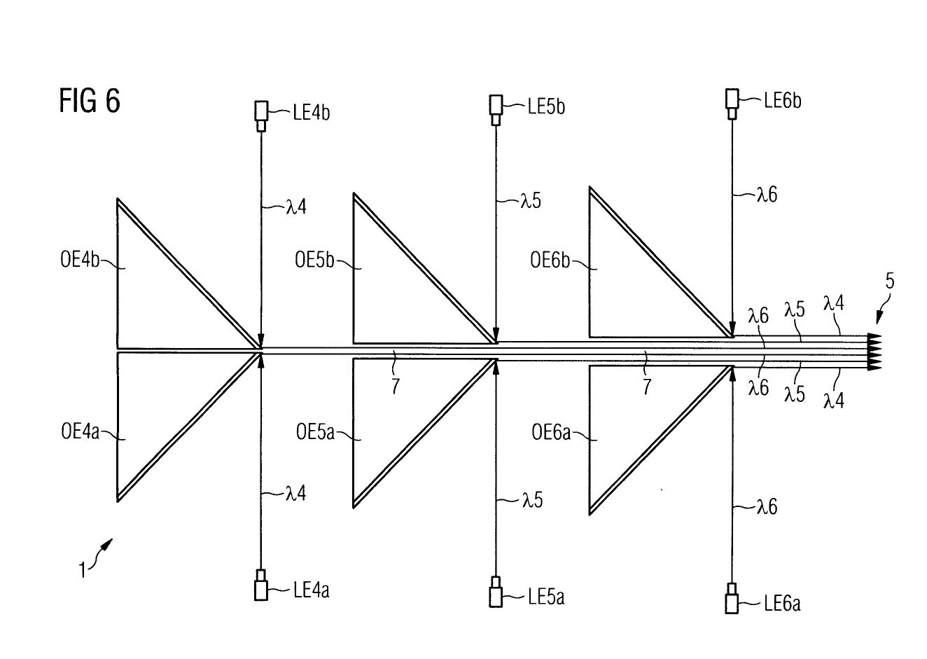

FIG. 6 shows an exemplary embodiment in which the laser diodes LE4a and LE4b only emit light of red laser radiation, the laser diodes LE5a and LE5b emit light of green laser radiation, and the laser diodes LE6a and LE6b emit light of blue laser radiation. In accordance with the color rule, therefore, by means of an addition in the light addition device 1, it is possible to form a beam bundle which not only adds the intensities of the individual light-emitting elements but also brings about its color impression through an addition of the colors, symbolized by its wavelengths λ6, λ5 and λ4. A light source is thus formed which, through mixing of the light components red, green and blue, is particularly suitable for projection applications.

The light source 5 thus becomes a light source having a small areal extent, the color tonality and coloration of which can be varied as desired from white light through to any other color shade. A very broad color spectrum can therefore be represented by varying the individual intensities of the individual laser diodes LE4a, LE4b, LE5a, LE5b, LE6a or LE6b. This is of great importance for applications in the area of projection technology, where light spots or image pixels of any desired color and of high intensity can be produced in this way.

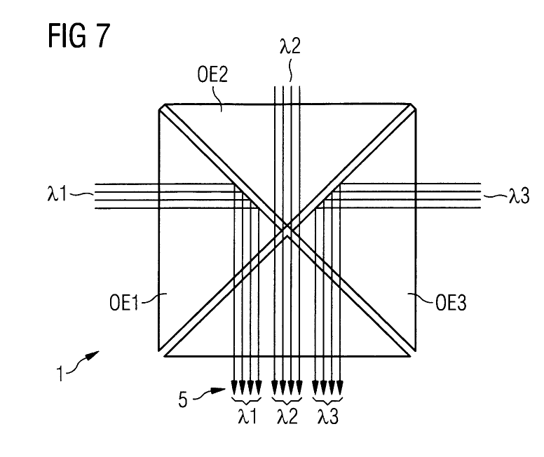

FIG. 7 shows an exemplary embodiment of the light addition device 1 in which the optical elements OE1, OE2 and OE3 are arranged to form a so-called X-cube. In accordance with the principle described above, here as well the surfaces of the optical elements OE1, OE2 and OE3 are correspondingly formed in reflective fashion. On account of the arrangement chosen in this exemplary embodiment, the reflective surface is situated between the individual optical elements OE1, OE2 and OE3. The reflective surface is formed in such a way that light of a predetermined wavelength λ1 or λ3 is directed at the reflective surface. In the example illustrated, an interface is formed between the optical element OE1 and the optical element OE2, the surface of said interface being configured in such a way that light of the wavelength λ1 is directed at the interface. Through the arrangement in the X-cube, the reflective surface is arranged at an angle of 45° with respect to the surface of the outer sides of the X-cube. A light radiation of the wavelength λ1 which impinges on the outer sides onto the optical element OE1 is therefore reflected at said interface and leaves the X-cube arrangement after deflection to an extent of 90°. Equally, at the interface of the optical elements OE2 and OE3, the surface is configured in such a way that a light of the wavelength λ3 which impinges on the optical element OE3 from outside is reflected. In this case, the interface is formed in such a way, for example by a thin-film optical coating, that a light of the wavelength λ2 which impinges on the optical element OE2 can penetrate through the interface unimpeded. This results in a total light beam which is formed in one direction from the individual light beams of the wavelengths λ1, λ2 and λ3, and forms a light source 5. The exemplary embodiment further shows that the light beams of the wavelengths λ1, λ2 and λ3, represented symbolically here in each case by four individual light beams, are for example directed onto the X-cube here already as the result from an upstream light addition device and can be added to one another a further time in said X-cube.

This shows that light addition devices 1 of the type described above can be combined and arranged one after another as desired. Consequently, not only is it possible for a high variation of individual laser diodes to be combined and the light intensities thereof to be added, but also multifarious possibilities in respect of application and possibilities in respect of extension are then afforded. Cascades of light addition devices can thus be formed, wherein light sources of high intensity can be formed by addition.

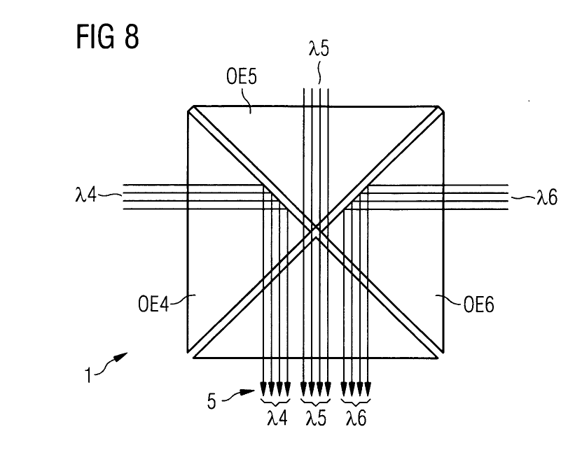

FIG. 8 shows an exemplary embodiment in which light of the wavelength for red light λ4, light of the wavelengths for green light 25 and light of the wavelength for blue light λ6 are added and combined in an X-cube to form a total light beam and a light source 5. The exemplary embodiment of FIG. 8 otherwise follows the principle of the exemplary embodiment in FIG. 7.

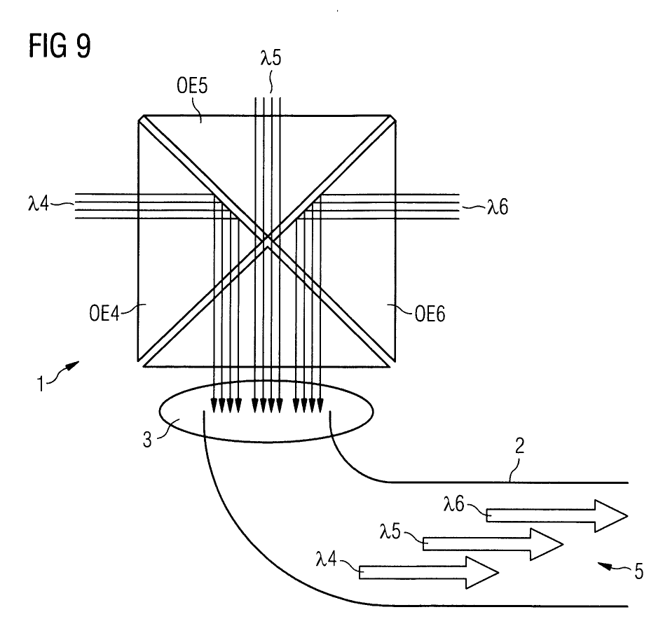

FIG. 9 shows a further exemplary embodiment, which is a development of the exemplary embodiment from FIG. 8, the light of the wavelengths λ4, λ5 and λ6 that emerges from the X-cube being introduced into an optical fiber 2 by means of an optical lens 3 and being forwarded in said fiber to any desired other location depending on the length of the fiber. The light source 5 is then situated at the end of the optical fiber 2. In this case, the optical fiber 2 is set up in such a way that the light beams of the wavelengths λ4, λ5 and λ6 are totally reflected at the lateral interfaces of said fiber, such that a virtually lossless light beam having the wavelengths λ4, λ5 and λ6 emerges at the end of the optical fiber. This is of particular importance, for example, for forming white light sources for illumination purposes in the areas of endoscopy and microscopy, where a point light source is required at locations that are in some instances difficult to access; likewise for projection applications in which red, green and blue light sources of high luminance are to be generated. This is of importance also for generating light sources having variable color tonalities and a high luminance, since the outer dimensions of the individual light sources, or laser diodes, and of the light addition device 1 have no influence whatsoever on the remote spot of the light source 5.

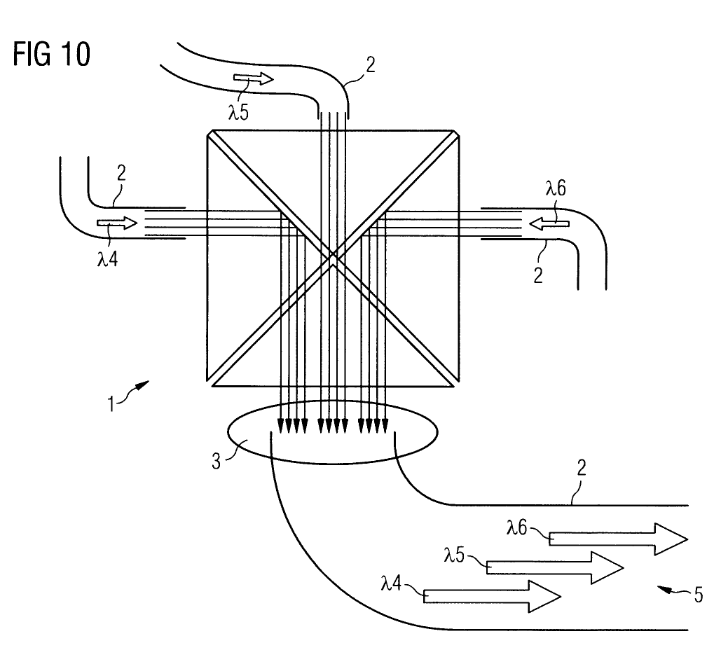

The exemplary embodiment of FIG. 10 shows a variant in which the light beams of the wavelengths λ4, λ5 and λ6 or else any other wavelengths can be fed into the light addition device by means of an optical fiber 2. This is not just restricted to the arrangement in accordance with an X-cube, but rather can in principle also be applied to all other arrangements, as shown in FIGS. 1 to 9.

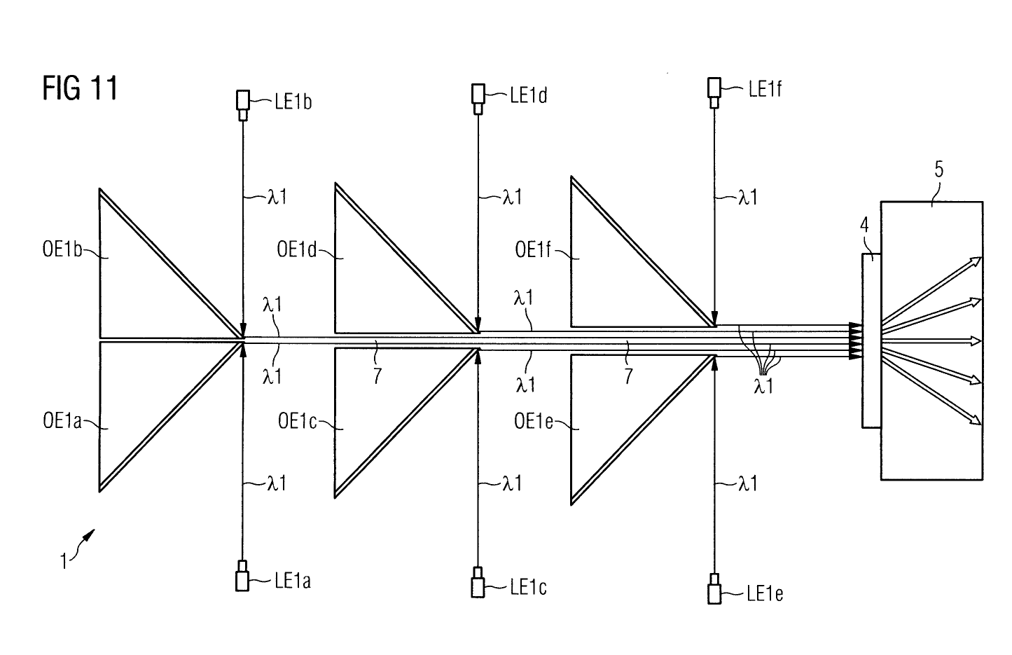

FIG. 11 develops the arrangement already described in FIG. 5 to the effect that the light beam of the wavelength λ1 that emerges from the light addition device 1 impinges on a converter device 4, the converter device 4 converting the wavelength of the impinging light. Thus, by way of example, in the exemplary embodiment shown, a laser radiation of 445 nm to 470 nm in conjunction with a Cer-doped YAG converter, which for example is applied to glass or plastic or silicate or is embedded therein, can be combined to form a white light source.

In this case, the abbreviation CER stands for cerium and thus describes a cerium-doped converter material, and the abbreviation YAG stands for yttrium aluminum garnet crystal. Consequently, Cer-doped YAG converter denotes a cerium-doped yttrium aluminum garnet crystal.

As an alternative to this, europium-based material can be used as converter material, whereby it is possible for example to achieve a red, green or blue conversion with lasers having wavelengths of 370 nm to 400 nm and a white light source can thus be produced by the combination thereof.

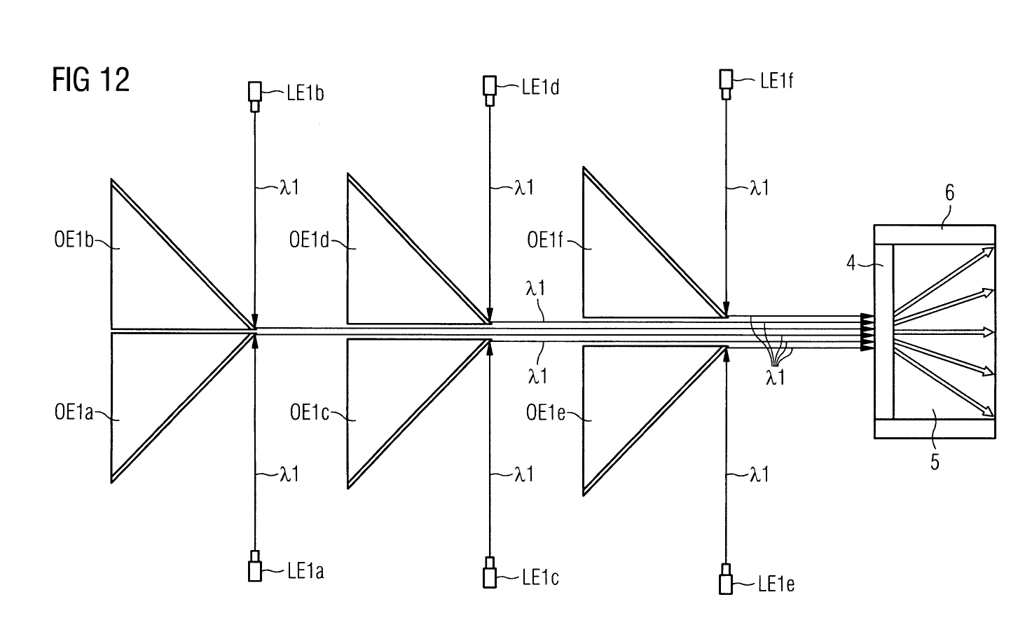

FIG. 12 develops the exemplary embodiment of FIG. 11 to the effect that heat caused by the conversion at the converter device 4 can be dissipated by a cooling device 6. The cooling device 6 is for example a cooling component through which water or some other cooling medium flows, or a cooling element having a high thermal conductivity such as, for example, a metal sheathing. In further aspects the exemplary embodiment from FIG. 12 corresponds to the exemplary embodiment already described with regard to FIG. 11.

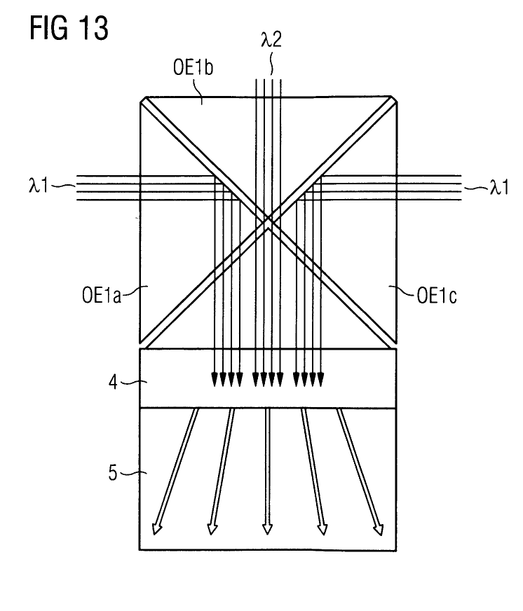

The exemplary embodiment of FIG. 13 shows a further variant, in which the converter device 4 is arranged directly at the beam output of the so-called X-cube, where it directly converts the wavelengths of the light beams emerging at the X-cube.

Consequently, it is possible to find suitable exemplary embodiments for a wide variety of uses in order in each case to obtain a light source whose areal extent is very small and whose luminance is very high.

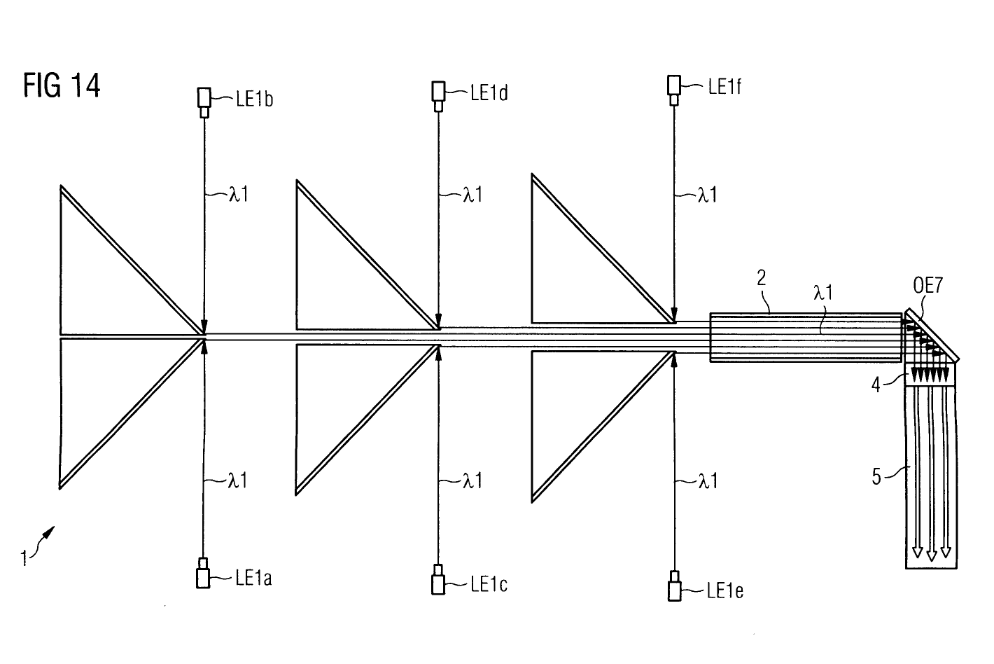

Thus, the exemplary embodiment of FIG. 14 shows a further embodiment comprising six laser diodes LE1a to LE1f, the light beams of which are added by means of the light addition device 1 and fed to the optical fiber 2. An optical element OE7 is arranged at the end of the optical fiber 2, said optical element representing a deflection prism. At the beam output of the optical element OE7, a light source 5 is formed by means of the converter device 4, which light source, depending on the converter material in interaction with the wavelengths of the light emitted by the laser diodes, has a light source having a small areal extent and predeterminable color tonality.

Even though laser diodes are used as light-emitting elements in the exemplary embodiments described above, the concept of the invention is not thereby exclusively restricted to laser diodes. Rather, other light-emitting elements are also suitable. The use of laser diodes is particularly suitable on account of their luminance and parallel-directed light emission.

Thus, with light-emitting diodes it is likewise possible to produce light sources having a small areal extent, the luminance of which is however very low, or greatly limited. An optical power density of approximately 0.1 kW/cm² is achieved with InGaN-based LEDs, which can have an emission area of approximately 1 mm×1 mm on a chip-size arrangement. Through a cascade-like arrangement of light addition devices, a high luminance can also be achieved by means of a multiplicity of light-emitting diodes of this type.

As an alternative to light-emitting diodes, with laser-based light sources such as, for example, InGaN-based lasers, it is possible to achieve a higher optical output power at each individual light-emitting element. The InGaN-based lasers, with an optically emissive area of 1 μm to 20 μm×0.3 μm, are significantly smaller than simple light-emitting diodes and therefore achieve an optical output power density of up to 40 000 kW/cm². As the optical power increases, the risk of the laser diode, in particular the facet of the laser, being damaged increases. By means of the light addition device, it is possible to combine individual output powers of a plurality of laser diodes, without the risk of the facet of a laser diode being destroyed, to form a light source whose light power is significantly greater than the light power of individual laser diodes. A cascade-like arrangement of light addition devices increases the possible luminances of the light sources that can be produced by a further factor.

The invention is not restricted by the description on the basis of the exemplary embodiments. Rather, the invention encompasses any new feature and also any combination of features, which in particular comprises any combination of features in the patent claims, even if this feature or this combination itself is not explicitly specified in the patent claims or exemplary embodiments.

We claim:

1. An optical arrangement comprising:
at least a first light-emitting element and a second light-emitting element; and
at least one light addition device arranged in such a way that the light from the first and the second light-emitting element are added to form a light beam.

2. The optical arrangement as claimed in claim 1, wherein the first light-emitting element and the second light-emitting element are respectively formed from a first semiconductor-based laser diode and a second semiconductor-based laser diode.

3. The optical arrangement as claimed in claim 1, wherein the first light-emitting element emits light of a first predetermined wavelength range, and the second light-emitting element emits light of a second predetermined wavelength range.

4. The optical arrangement as claimed in claim 1, further comprising a converter device.

5. The optical arrangement as claimed in patent claim 4, wherein the converter device is disposed downstream of the light addition device.

6. The optical arrangement as claimed in claim 1, further comprising at least one optical fiber.

7. The optical arrangement as claimed in claim 6, wherein the optical fiber is disposed downstream of the light addition device.

8. The optical arrangement as claimed in claim 1, wherein the light addition device is formed from at least one optical element with an interface, the interface being formed in such a way that a light of a predetermined wavelength range which impinges at a predetermined angle is reflected at the interface and light outside said predetermined wavelength range penetrates through the interface.

9. The optical arrangement as claimed in claim 1, wherein the converter device is thermally coupled to a cooling device.

10. An optical method, in which light from a first light-emitting element is added with the light from a second light-emitting element to form a light beam.

11. The optical method as claimed in patent claim 10, wherein the first light-emitting element emits a first individual light beam and the second light-emitting element emits a second individual light beam.

12. The optical method as claimed in claim 10, wherein the first individual light beam comprises a first predetermined wavelength range, and the second individual light beam comprises a second predetermined wavelength range.

13. The optical method as claimed in claim 10, wherein the wavelength range of the light beam is converted.

14. The optical method as claimed in claim 10, wherein the light is fed to the addition by means of an optical fiber from at least one of the light-emitting elements, and/or the light beam is guided to a location at a distance by means of an optical fiber.

15. The optical method as claimed claim 10, wherein the first individual light beam and the second individual light beam are fed to an optical element from mutually deviating directions, and at the optical element, at an interface, the first individual light beam penetrates through the interface and the second individual light beam is reflected at the interface, the first and the second individual light beam leaving the interface in a common light beam.

16. The optical method as claimed in claim 10, wherein heat formed by the conversion is dissipated.
